(19) United States
(12) Patent Application Publication
(10) Pub. No.: US 2012/0331445 A1
(43) Pub. Date: Dec. 27, 2012

(54) Unchanged Object Management

(75) Inventors: Paolina Centonze, Amawalk, NY (US); Peter K. Malkin, Ardsley, NY (US); Marco Pistoia, Amawalk, NY (US)

(73) Assignee: International Business Machines Corporation, Armonk, NY (US)

(21) Appl. No.: 13/603,778

(22) Filed: Sep. 5, 2012

Related U.S. Application Data
(63) Continuation of application No. 12/900,643, filed on Oct. 8, 2010.

(51) Int. Cl. G06F 9/44

(52) U.S. Cl. 717/110

(57) ABSTRACT

Apparatus and program products are disclosed. Using a static analysis performed on code, the code is analyzed to determine a set of unchanged objects and modifying the code to exercise a singleton-pattern technique for one or more members of the set of unchanged objects. The modified code is output. Another technique includes accessing code from a client, and in response to any of the code being source code, compiling the source code into object code until all the code from the client comprises object code. Using a static analysis performed on the object code, the object code is analyzed to determine a set of unchanged objects and the object code is modified to exercise a singleton-pattern technique for one or more members of the set of unchanged objects. The modified object code is returned to the client.

### CROSS-REFERENCE TO RELATED APPLICATIONS

This is a continuation of U.S. patent Ser. No. 12/900,643, filed on Oct. 8, 2010, which is incorporated by reference in its entirety.

### BACKGROUND

This invention relates generally to analysis of code such as object code, byte code, executable code, and libraries, and, more specifically, relates to static analysis of code.

Object-oriented (OO) programming has many benefits. For instance, with OO programming, a programmer can define a single object and then instantiate that object multiple times during program execution. Furthermore, objects also may inherit characteristics from other objects. This allows objects to be easily reused in different programs.

While OO programming has many benefits, this type of programming may also be improved.

### SUMMARY

In an aspect of the invention, a method includes, using a static analysis performed on code, analyzing the code to determine a set of unchanged objects and modifying the code to exercise a singleton-pattern technique for one or more members of the set of unchanged objects. The method also includes outputting the modified code. Apparatus and program products are also disclosed.

In another exemplary aspect of the invention, a method is disclosed that includes accessing code from a client, and in response to any of the code being source code, compiling the source code into object code until all the code from the client comprises object code. The method further includes, using a static analysis performed on the object code, analyzing the object code to determine a set of unchanged objects and modifying the object code to exercise a singleton-pattern technique for one or more members of the set of unchanged objects. The method additionally includes returning the modified object code to the client.

### BRIEF DESCRIPTION OF THE SEVERAL VIEWS OF THE DRAWINGS

FIG. 1 is a flowchart of an exemplary method for unchanged object management;

FIG. 2 is a flowchart of an exemplary method for analyzing code to determine a set of target unchanged objects;

FIG. 3 is a block diagram of a system for unchanged object management in accordance with an exemplary embodiment;

FIG. 4 is a flowchart of an exemplary method for determining unchanged objects;

FIG. 5 is a flowchart of another exemplary method for determining unchanged objects;

FIG. 6 is a flowchart of an exemplary method for modifying code so that all uses of the members of a set of target unchanged objects exercise the singleton-pattern technique; and

FIG. 7 is a flowchart of an exemplary method for determining immutable objects.

### DETAILED DESCRIPTION

As previously described, object-oriented (OO) programming has many benefits. However, OO systems allow for the creation of multiple objects even when these objects logically represent the same entity. There are at least three problems associated with this approach:

1. In OO systems, objects must implement two methods: equals and hashCode. The equals method takes another object as a parameter: a.equals(b) returns true if a and b logically represent the same entity. The equals method must be carefully implemented. Typically, developers test for the equality of the inner fields of the two objects, which implies that the equals method is called recursively until the equality is tested on fields of primitive types or strings. The hashCode method produces a number within a fixed range, based on the object on which the method is called. This method is very important for when objects are inserted into hashSets. When an object is inserted into a hashSet, its hashCode is computed first, and the object is then inserted into the hashSet in the bucket corresponding to the object's hashCode. Before the object is inserted, that bucket is scanned to verify that another equal object was not previously inserted. This way, the set will not have duplicate entries, in compliance with the mathematical definition of “set”. However, if hashCode and equals are not implemented consistently, errors (called “bugs”) can arise. For example, if two equal objects could end up having different hashCodes, then they would be inserted in different buckets of the same hashSet, giving rise to duplicated entries in a set. The consequences of a bug of this type could be very serious.

2. Another limitation of this design is that the design can take up a lot of memory. The fact that logically equivalent objects can be instantiated multiple times in the same system can cause unnecessary memory consumption. Ideally, no object should be instantiated if a logically equivalent object (with the equals method returning true) has already been instantiated.

3. Finally, another limitation of this approach is the time consumed in executing the equals method every time. As mentioned above, the equals method must be implemented to test the equality of all the inner fields of the objects, and this process triggers a cascading test where all the fields of the fields are tested for equality, recursively. If it were possible to prevent the creation of an object every time another object logically equivalent to the original object already exists in memory, then it would not be necessary to perform such expensive equality tests, and it would be sufficient to test for pointer equality (e.g., using the == operator).

Solutions to these problems are ad-hoc. Developers must implement a caching mechanism, checking for existing objects in caches and returning those objects instead of creating new ones whenever possible. Moreover, these solutions cannot be applied to library code, where classes have already been implemented without such caching mechanisms, and whose source code may not even be available.

Exemplary techniques are proposed herein to solve at least the three problems described above. A static analysis can statically (that is, without executing code) detect the equality of objects in code. If two objects are deemed to be equal, then the static analysis can indicate that the two objects should actually be the same object. Furthermore, the static analysis can direct the work of a bytecode rewriter to modify library code whose source code is no longer available.

In an exemplary embodiment, the modifications recommended by the static analysis are the following, where the modifications modify code so that so that all uses of members of a set of target unchanged objects exercise the singleton-pattern technique:

1. Each class has an associated cache.

2. Every time the constructor of a class is called, the corresponding cache is consulted.

3. If an object with the characteristics specified in the constructor calls already exists in the cache, the object is not created. Rather, the object from the cache is returned.

4. If an object with the characteristics specified in the constructor calls does not already exist in the cache, the object is created, added to the cache, and returned.

As a further optimization, the above modifications can be applied only if two or more equal objects are statically detected. Further modifications include, for classes for which a cache has been created, calls to the equals method can be replaced with the == operator (that is, an operator having two equals signs in a row). An additional optimization includes the scenario where “equals” is a singleton-relevant-operator, with “==” being its singleton-relevant-operator-equivalent.

An exemplary embodiment of the invention is not limited to client code, but can be applied to library code as well. With library code, the typical disadvantage is that source code may not be available. An exemplary solution is proposed based on bytecode rewriting, which modifies the bytecode of the library. The equality principle (a==b)==>(a.equals(b)==true) guarantees that the modifications listed above do not modify the program semantics, e.g., as long as the static analysis is sound.

It is further noted that the methods disclosed herein could also be provided as a service. For example, in an exemplary embodiment, the service provider would come to a client's site, provide a caching service (e.g., a database), run the above method on all of the client's object code so as to modify the object code, and then execute the modified object code. As another example, the client can send code (e.g., source, object, executable code) to a server and the server will perform the method(s) described herein on all of the client's code so as to modify the code, and then send the modified code to the client. The client may also allow the server to access the client's code by allowing the server access to an internal system having the client code. These exemplary techniques allow the client to receive the operational benefit of the above invention without having to actually execute the techniques described herein.

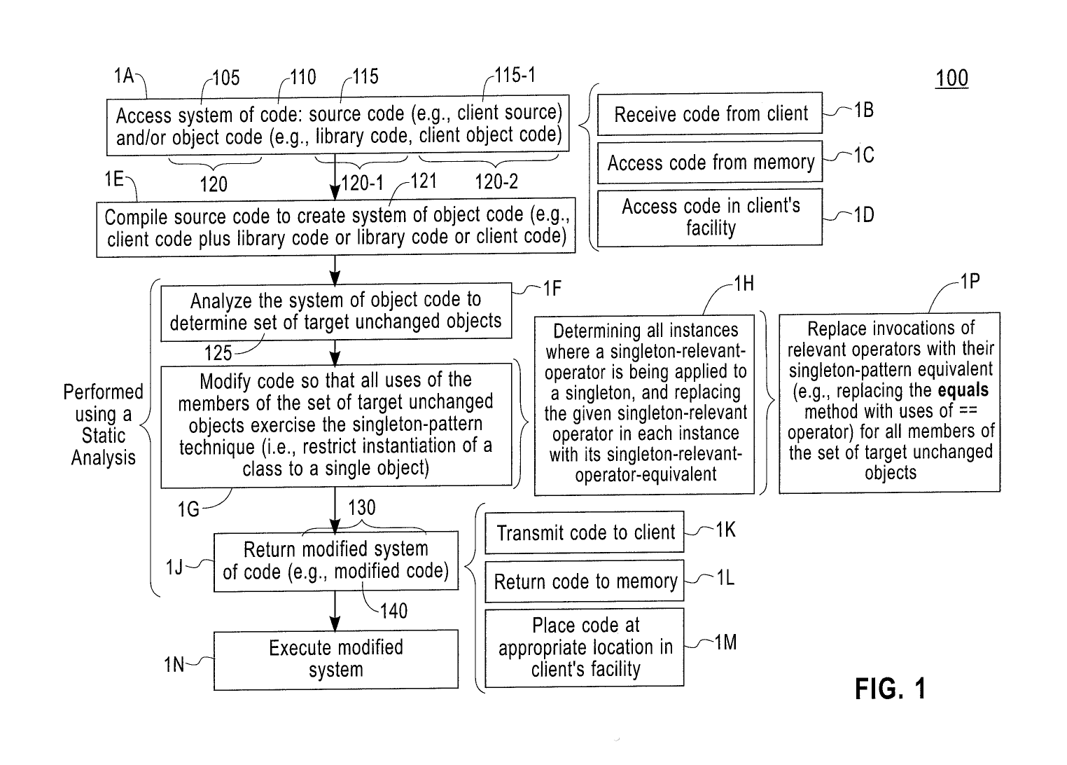

Turning now to the exemplary embodiments, FIG. 1 is a flowchart of an exemplary method 100 for unchanged object management. Method 100 begins in block 1A, when a system 105 of code 110 is accessed. The code 110 includes one or more of source code 115 (e.g., client source code 115-1) or object code 120 (e.g., library code 120-1 and/or client object code 120-2). A typical system would include, e.g., client source code 115-1 and library object code 120-1. This allows the client source code 115-1 to be compiled (block 1E) and thereby create a “complete” program, e.g., a system 121 of object code 120. However, other examples are possible. For instance, method 100 could operate only on the library object code 120-1 or only on source code 115 (e.g., after compiling in block 1E to create object code 120). In the latter case (where only source code 115 is operated on), compilation would not be necessary.

Examples of accessing the system 105 of code 110 include receiving code 110 from a client (block 1B), accessing code from memory (block 1C), or accessing code in a client's facility (block 1D). A “client” includes internal customers (e.g., one division of an entity, where another division of the entity performs the techniques described herein) or external customers (e.g., one division of an entity performs the techniques described herein on code from another entity). Block 1B may be performed by receiving the code 110 via, e.g., a network interface. It is noted that block 1B may entail placing the received code into a memory and accessing the memory at a later time (block 1C).

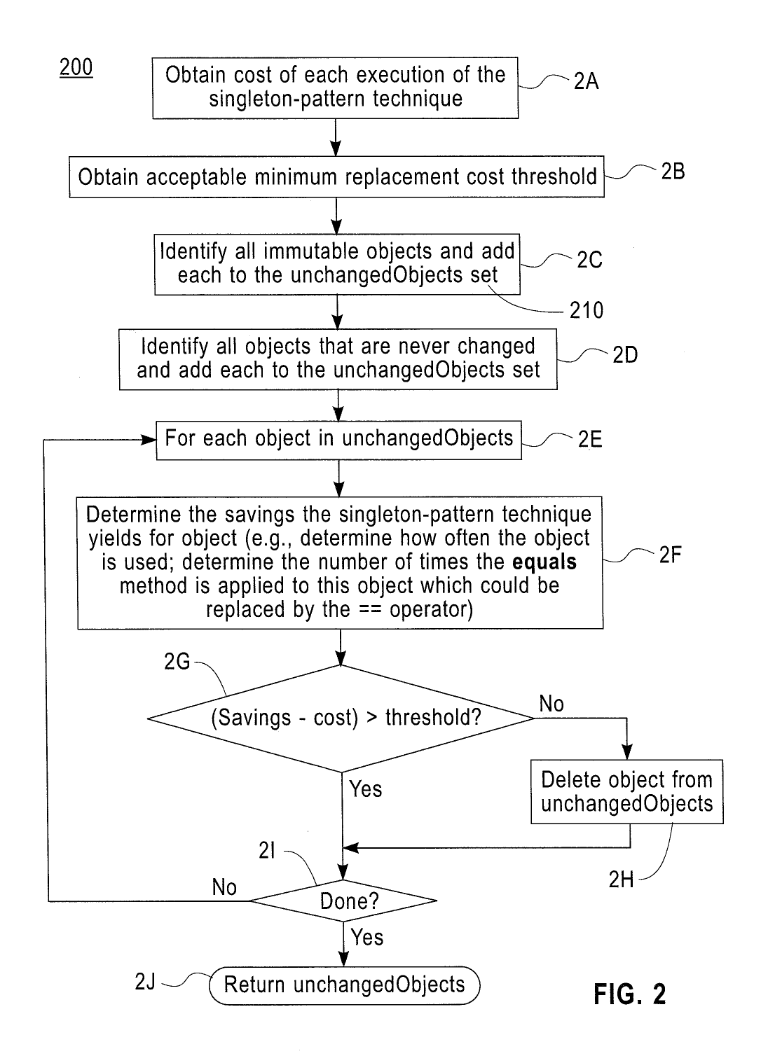

Blocks 1F, 1G, and optionally 1J are performed statically, using a static analysis. That is, the static analysis does not execute the object code 120 (or system 121 of object code 120) and, instead, operates on object code 120 without executing such code. In block 1F, the system 121 of object code 120 is analyzed to determine a set 125 of “target” unchanged objects. The analysis and determination of target unchanged objects is described in detail in reference to FIG. 2, as an exemplary embodiment. In short, target unchanged objects are unchanged objects where a metric for a singleton-pattern technique meets a certain threshold. An unchanged object is an object that does not change during subsequent runtime (e.g., execution). An object changes if its value—or the values of any of its instance variables—changes. For example, given an object of a complex type, such as Employee, an instance, employee_123, would change if any of its instance variables changes, e.g., employee_123.lastname changes from “Doe” to “Smith”. A static analysis can determine whether an object would change during subsequent runtime.

In block 1G, the object code 120 is modified so that all uses of the members of the set 125 of target unchanged objects exercise the singleton-pattern technique. That is, all members of the set 125 of target unchanged objects restrict instantiation of a class to a single object. One example of block 1G is provided in block 1H, where all instances are determined where a singleton-relevant-operator is being applied to a singleton, and where the given singleton-relevant operator is replaced in each instance with its singleton-relevant-operator-equivalent. Another example of block 1G is shown in block 1P, where invocations of relevant operators are replaced with their singleton-pattern equivalent (e.g., replacing the equals method with uses of the == operator) for all members of the set 125 of target unchanged objects. An example could be the hashCode( ) method, which can be invoked on every Java object in virtue of the fact that java.lang.Object (the superclass of all objects in Java) implements hashCode( ). If objects of a particular type follow the singleton pattern, this means no two different objects can respond true to equals( ). This simplifies the implementation of hashCode( ) too in that it is enough to hash the pointer to the object as opposed to having to compute expensive hashes based on the internal representation of each object.

In block 1J, the modified system 130 of modified object code 140 is returned (e.g., output). The output could simply be to a memory (e.g., a database). Examples of block 1J include returning the modified object code 140 to the client by transmitting the modified object code 140 to a client (block 1K), returning the modified object code 140 to memory (block 1L) or returning the code to the client by placing the modified object code 140 at an appropriate location in the client's facility (block 1M). For example, for the latter, the source code 115 could be accessed from a database (block 1D) and the modified code 140 could be placed back into the database (block 1M).

In block 1N, the modified system 130 of modified object code 140 is executed, e.g., by a runtime environment. It is noted that block 1N might not be performed, such as if method 100 is used to operate solely on library object code 120-1 or solely on client object code 120-2 and the client object code 120-2 needs library object code 120-1 to operate and the code 120-1 is not available.

Referring now to FIG. 2, a flowchart is shown of an exemplary method 200 for analyzing code and determining a set 125 of target unchanged objects. Method 200 is an example of how block 1F of FIG. 1 might be performed.

There are two dimensions to cost in the context of the current invention: memory usage and run time load. As described above, one drawback with having several instances of an object, each with the same value, is that computer memory is being wasted. If there are three instances of a Java String object, each with the value “No,” for example, then (a minimum of) 6 bytes of memory are being used, one byte for each character. If these three objects never change value, then only one String object instance with a value of “No” is actually needed, requiring only 2 bytes. Additionally (also as described above) Object methods, e.g. equals( ) and hashCode( ) add to the load placed on a given run time. For example, to execute the equals( ) method on two String objects both of whose value=“No”, the runtime first has to retrieve and compare the first character “N,” and then retrieve and compare the second character “o.” Alternatively, if only a single cached value is used, then the run time only needs to perform a numeric comparison, ==, of the instances. On the other hand, caching singletons has an initial cost. In fact, every time a new object of a class implementing the singleton pattern is constructed, the caching logic has to look into the cache to see if an object with identical characteristics (e.g., for String objects, a String with the same sequence of characters) has already been constructed and cached. This initial cost is overcome if a program attempts to construct multiple instances of the same object. If only one instance with certain characteristics is being constructed, then there is no need for caching and that initial cost can be saved. In block 2A, cost of each execution of the singleton pattern technique is obtained. In block 2B, acceptable minimum replacement cost threshold is obtained.

Block 2C concerns identifying all immutable objects and adding each immutable object to the unchangedObjects set 210. An immutable object is an object that cannot be changed during subsequent runtime execution. Immutable objects possess a stronger property than unchanged objects. Unchanged objects are not mutated during the execution of a certain program. Immutable objects are also not mutated, but this property does not depend on a particular program; they are not mutated because they cannot be mutated. After the constructor has completed running, the state of an immutable object remains the same throughout the life of that object. In essence, an immutable object is also unchanged, but the opposite is not necessarily true.

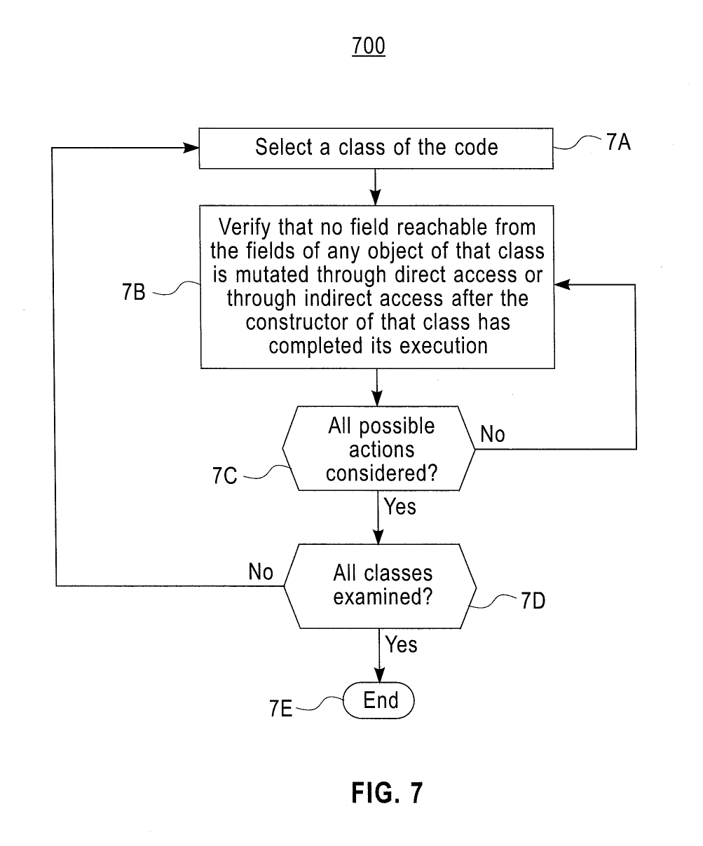

As mentioned above, immutable objects cannot be mutated. Instead, this is a property enforced by the class to which those objects belong, and for this reason, it is possible to determine immutable objects without having to analyze the entire program. An analysis to compute immutable objects proceeds as follows (see FIG. 7). For each class of the code (e.g., software program) (block 7A), the analysis verifies that no field reachable from the fields of any object of that class is mutated through direct access (e.g., a.f=x mutates field f through a direct access) or through indirect access (a.setF(x) is an indirect way to modify field f through method setF) after the constructor of that class has completed its execution (block 7B). This analysis requires considering all the possible actions that can be performed by invoking any of the methods of that class (Block 7C). If all possible actions have not been considered (block 7C=NO), the method 700 continues in block 7B; otherwise (block 7C=YES), the method 700 continues in block 7D. If all classes have not been examined (block 7D=NO), the method 700 continues in block 7A; otherwise (block 7D=YES), the method 700 ends in block 7E.

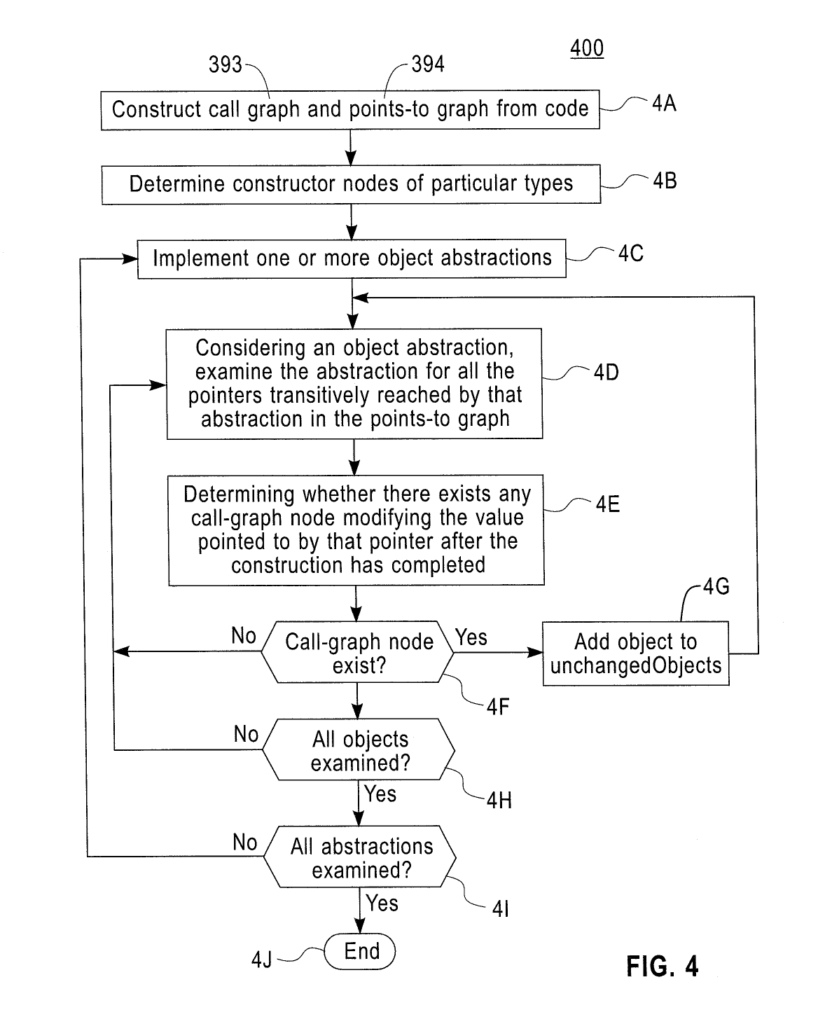

Returning to FIG. 2, in block 2D, all objects are identified that are never changed, and each of these are added to the unchangedObjects set 210. Such objects can be identified as follows (see FIG. 4). First, the call graph and points-to graph of the program under analysis are constructed (block 4A of method 400 of FIG. 4). The call graph 393 is a graph in which each node represents a method, and each edge represents a method invocation. A points-to graph 394 is bipartite graph in which nodes represent either instances or pointers. An edge from an instance to a pointer represents the fact that that instance has a field represented by that pointer. An edge from a pointer to an instance represents the fact that that pointer can point to that instance during the program execution. To detect unchanged objects of a particular type, the analysis first looks for constructor nodes of that type (block 4B). Constructor nodes are those representing calls to constructors, where objects are instantiated.

There are several object abstractions that can be implemented (block 4C). An exemplary one consists of abstracting objects based on their allocation sites. In other words, two objects are considered equivalent (and are, therefore, abstracted into the same static representation) if they share the same allocation site. More granular abstractions are possible, whereby, for example, two objects can be considered equivalent if they share not only the same allocation site, but also the caller of the method where the allocation site resides. Less granular abstractions are also possible whereby, for example, two objects are considered equivalent if they have the same type.

The analysis includes then of considering an object abstraction and looking for all the pointers transitively reached by that abstraction in the points-to graph (block 4D), determining whether there exists any call-graph node modifying the value pointed to by that pointer after the construction has completed (block 4E). If a call-graph node exists (block 4F=YES), the object corresponding to the call-graph node is added to a set of unchanged objects (block 4G), such as unchangedObjects. If not (block 4F=NO), the method 400 continues in block 4D. If all objects have not been examined (block 4H=NO), the method 400 also continues in block 4D. If all methods have been examined (block 4H=YES), it is determined if all abstractions have been examined (block 4I). If not, the method continues in block 4C; if so, the method ends in block 4I. At this point (after block 2D), the unchangedObjects set 210 should contain all objects that are not changed during a subsequent runtime execution of the system 121 of object code 120.

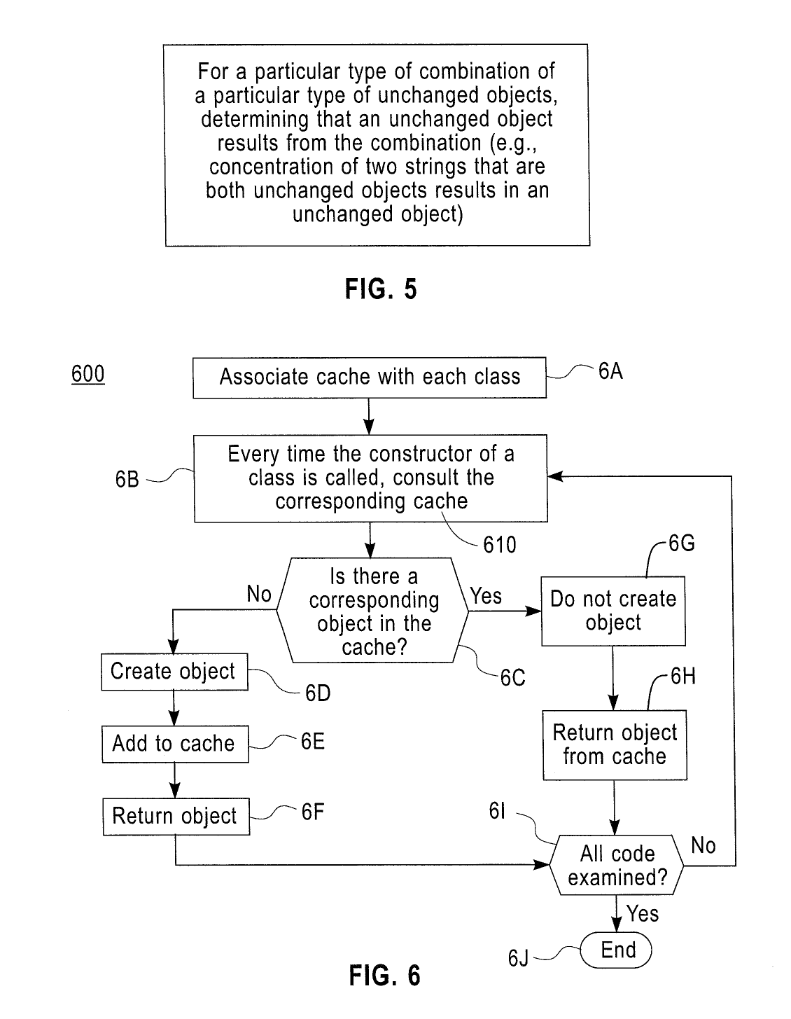

Additionally, in order to identify all objects that are never changed, for a particular type of combination of a particular type of unchanged objects, it can be determined that an unchanged object results from the combination. For instance, concatenation of two strings that are both unchanged objects results in an unchanged object. This method is shown in FIG. 5. It is noted that this method could be combined with other methods, such as the method shown in FIG. 4.

Returning to FIG. 2, blocks 2E through 21 reduce the objects in the unchanged Objects set 210 from all unchanged objects to a set 125 of target unchanged objects. The set 125 of target unchanged objects are those unchanged objects where a metric for a singleton-pattern technique meets a certain threshold. This prevents the single-pattern technique from imposing a cost that is greater than a savings by some predetermined amount (e.g., determined by a threshold) on the system 121 of object code 120.

For each object in unchangedObjects (block 2E), the savings that the singleton-pattern technique yields for a selected object are determined (block 2F). Block 2F may be accomplished by determining how often the object is used. As another example, block 2F may be accomplished by determining the number of times the equals method or the hashCode( )method or both is applied to this object, where the equals method could be replaced by the == operator). If the cost determined in block 2A subtracted from the savings determined in block 2F is greater than the threshold determined in block 2B (block 2G=Yes), the method 200 continues in block 2I. Otherwise (block 2G=No), the method 200 continues in block 2H, where the unchanged object is deleted from the unchangedObjects set 210. The method 200 continues in block 2I.

In block 2I, it is determined if there are no more objects in the unchangedObjects set 210. If there are more objects in the unchangedObjects set 210 (block 2I=No), the method 200 continues in block 2E, where another unchanged object is selected. If so (block 2I=Yes), the method 200 ends in block 2J.

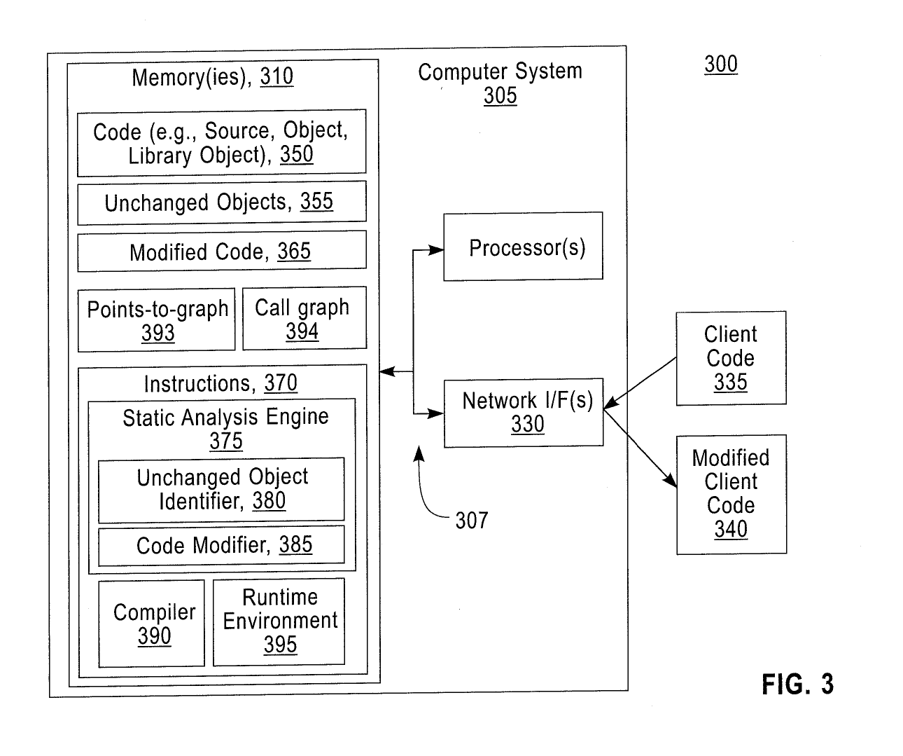

Referring to FIG. 3, a block diagram is shown of a system 300 for unchanged object management in accordance with an exemplary embodiment. System 300 includes computer system 305, comprising one or more memories 310, one or more processors 320, and one or more network interfaces (I/Fs) 330. The one or more memories 310, one or more processors 320, and one or more network interfaces (I/Fs) 330 are interconnected via one or more buses 307. It is noted that the one or more buses 307 may also be communications link(s) such as an Infiniband communications link. The one or more network interfaces 330 may be wired or wireless network interfaces.

The one or more memories 310 include code 350, unchanged objects 355, modified code 365, a points-to graph 393, and a call graph 394. The code 350 could include the source code 115, object code 120, or any other code. The unchanged objects 355 can include the unchanged objects in the unchangedObjects set 210. That is, the unchanged objects 355 can include all unchanged objects (e.g., the unchanged objects discovered after block 2D of FIG. 2), and a typically reduced set of unchanged objects after blocks 2E to 21 have been performed. In an exemplary embodiment, the unchanged objects 355 are the unchangedObjects set 210. The modified code 365 is the modified code that occurs after methods 100 and 200 have been performed on the code 350.

The instructions 370 are computer readable program code that, when executed by the one or more processors 320, cause the computer system 305 to perform one or more of the actions described herein. The instructions 370 include a static analysis engine 375, which includes an unchanged object identifier 380, and a code modifier 385. The instructions 370 further include a compiler 390 and a runtime environment 395.

The static analysis engine 375 creates the points-to graph 393, and call graph 394. The unchanged object identifier 380 performs, e.g., block 1F and method 200 of FIG. 2 (including FIGS. 4 and 5) and identifies unchanged objects 355 using a static analysis. It is noted that the analysis of method 200 need only determine unchanged objects using blocks 2C and 2D, and the other blocks 2A, 2B, 2E through 21 would not be performed. In this exemplary embodiment, the target unchanged objects would not be determined, and the unchanged objects 355 would include all discovered unchanged objects.

The code modifier 385 performs code modification as described above in reference to blocks 1G, 1H, 1P, and 1J. It is noted that this structure is merely exemplary. For instance, the unchanged object identifier 380 and code modifier 385 may be formed into a single program, or could be further subdivided.

The compiler 390 is used to compile source code 115 into object code 120. The compiler 390 performs block 1E of FIG. 1. The runtime environment 395 is used to execute the modified system 130 of modified object code 140 (e.g., block 1N of FIG. 1).

In an example, the code 350 is received over the one or more network interfaces 330 as client code 335, which may be client source code 115-1, client object code 120-2, or both. After the analysis described in FIG. 1 and determination of the modified code 365, the modified code 365 is communicated to the client over the one or more network interfaces as the modified client code 340.

A few examples have been described of modifying code so that all uses of the members of the set of target unchanged objects exercise the singleton-pattern technique, another technique is now described more specifically in relation to FIG. 6. Many elements of FIG. 6 have previously been briefly described above. In an exemplary embodiment, method 600 begins when each class is associated with a cache 610 (block 6A). Every time the constructor of a class is called, the corresponding cache 610 is consulted (block 6B). If an object with the characteristics specified in the constructor calls already exists in the cache (block 6C=YES), the object is not created (block 6G). Rather, the object from the cache is returned (block 6H).

If an object with the characteristics specified in the constructor calls does not already exist in the cache (block 6C=NO), the object is created (block 6D), added to the cache (block 6E), and returned (block 6F). In block 6I, it is determined if all the code has been examined. If not (block 6I=NO), the method 600 continues in block 6B. If so (block 6I=YES), the method 600 ends in block 6J.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer program product, comprising:
a computer readable storage medium having computer readable program code embodied therewith, the computer readable program code comprising:
computer readable program code for using a static analysis performed on code, analyzing the code to determine a set of unchanged objects and modifying the code to exercise a singleton-pattern technique for one or more members of the set of unchanged objects; and
computer readable program code for outputting the modified code.

2. The computer program product of claim 1, further comprising computer readable program code for executing the modified code.

3. The computer program product of claim 1, wherein the code comprises library object code, analyzing further comprises analyzing the library object code to determine a set of unchanged objects, modifying further comprises modifying the library object code to exercise a singleton-pattern technique for one or more members of the set of unchanged objects, and outputting further comprises outputting the modified library object code.

4. The computer program product of claim 1, wherein the code comprises source code and the computer readable program code further includes, prior to analyzing, compiling the source code into object code, and analyzing the code further comprises analyzing the object code to determine a set of unchanged objects and modifying the object code to exercise a singleton-pattern technique for one or more members of the set of unchanged objects.

5. The computer program product of claim 1, wherein modifying further comprises:
determining all instances where a singleton-relevant-operator is being applied to a singleton, and replacing the singleton-relevant operator in each instance with its singleton-relevant-operator-equivalent.

6. The computer program product of claim 1, wherein analyzing further includes, for each unchanged object in the set of unchanged objects:
calculating whether savings yielded by use of the singleton-pattern technique for the unchanged object exceeds a cost of applying the singleton-pattern technique by a threshold, and
in response to calculating that the savings yielded by use of the singleton-pattern technique for the unchanged object does not exceed the cost of applying the singleton-pattern technique by the threshold, removing the unchanged object from the set of unchanged objects.

7. The computer program product of claim 1, wherein analyzing further comprises for a particular type of combination of a particular type of unchanged objects results, determining that an unchanged object results from the combination.

8. An apparatus, comprising:
at least one memory comprising computer code; and
at least one processor,
the computer code controlling the at least one processor to perform at least the following:
using a static analysis performed on code, analyzing the code to determine a set of unchanged objects and modifying the code to exercise a singleton-pattern technique for one or more members of the set of unchanged objects; and
outputting the modified code.

9. The apparatus of claim 8, wherein modifying further comprises:
determining all instances where a singleton-relevant-operator is being applied to a singleton, and replacing the singleton-relevant operator in each instance with its singleton-relevant-operator-equivalent.

10. The apparatus of claim 8, wherein analyzing further includes, for each unchanged object in the set of unchanged objects:
calculating whether savings yielded by use of the singleton-pattern technique for the unchanged object exceeds a cost of applying the singleton-pattern technique by a threshold, and
in response to calculating that the savings yielded by use of the singleton-pattern technique for the unchanged object does not exceed the cost of applying the singleton-pattern technique by the threshold, removing the unchanged object from the set of unchanged objects.

11. The apparatus of claim 8, wherein analyzing further comprises for a particular type of combination of a particular type of unchanged objects results, determining that an unchanged object results from the combination.
